(19) United States
(12) Patent Application Publication
(10) Pub. No.: US 2026/0218630 A1
(43) Pub. Date: Jul. 30, 2026

(54) A RING SEGMENT FOR A GAS TURBINE, A METHOD TO OPERATE A GAS TURBINE AND COMPUTER-IMPLEMENTED METHOD TO DESIGN AND/OR MANUFACTURE SAID RING SEGMENTS

(71) Applicant: Siemens Energy Global GmbH & Co. KG, Munich, Bayern (DE)

(72) Inventors: Tobias Mellentien, Berlin (DE); Martin Boeff, Gelsenkirchen-Buer (DE); Florian Aute, Duisburg (DE)

(73) Assignee: Siemens Energy Global GmbH & Co. KG, Munich, Bayern (DE)

(21) Appl. No.: 19/157,362

(22) PCT Filed: Jan. 17, 2024
(86) PCT No.: PCT/EP2024/051001

§ 371 Date: Aug. 17, 2025

(30) Foreign Application Priority Data
Feb. 28, 2023 (GB) 2302900.2

(51) Int. Cl. F01D 25/24; F01D 25/12

(52) U.S. Cl. CPC F01D 25/24; F01D 25/12; F05D 2230/10; F05D 2230/21; F05D 2230/23

(57) ABSTRACT

A ring segment for a gas turbine engine includes a base body having a first inner surface, which is subjectable to a hot working medium, and a second outer surface which is arranged opposite of the first surface, wherein the first surface extends in an axial direction from a first axial end to a second axial end and in a circumferential direction from a first lateral end to a second lateral end. The first surface includes a nominal area, which extends along both axial ends and both lateral ends. To reduce the average radial gap between airfoil tips and the first surface, and to improve the efficiency of the gas turbine engine, the nominal area delimits completely a center area of the first surface, the center area comprising a trough.

### CROSS REFERENCE TO RELATED APPLICATIONS

This application is the U.S. National Stage of International Application No. PCT/EP2024/051001 filed 17 Jan. 2024, and claims the benefit thereof, which is incorporated by reference herein in its entirety. The International Application claims the benefit of United Kingdom Application No. GB 2302900.2 filed 28 Feb. 2023.

### FIELD OF THE INVENTION

The invention relates to a ring segment for a gas turbine, a method to operate a gas turbine and a computer-implemented method to design and manufactures such ring segment.

### BACKGROUND TO THE INVENTION

Ring segments of the prior art, also known as blade outer air seals, are usually arranged within the gas turbine for bordering the hot gas path of a turbine section. These ring segments are arranged along the circumferential direction whereby all segments of a circumference create a ring-shaped arrangement. Withing the ring-shaped arrangement and during operation of the gas turbine, the tips of rotor blades mounted on the rotor of the turbine move along the hot gas path boundary formed by said ring segments.

The ring segments are usually carried by a vane carrier, which is, in cross section perpendicular to the rotational axis of the gas turbine, of circular shape. For stationary gas turbines the vane carrier is split into a lower half and an upper half. They comprise grooves extending in the circumferential direction, into which the ring segments could be slid to their dedicated position one by one to form the before-mentioned outer border of the hot gas path. To provide a concentric outer hot gas path boundary the ring segments must be rigidly hold from the vane carrier in a fixed position. Such an arrangement is known from EP 3 118 419 A1.

Further, U.S. Pat No. 4,784,569 A discloses a shroud ring with an adjusted hot gas surface. This reverse curvature or concave surface permits the shroud ring to deform under elevated temperatures to the extent, without any significant change in the original design clearance between ring and turbine blades and without danger of rubbing contact between the turbine blades and the ring.

During operation of the gas turbine the ring segments are subjected to a hot gas. The thermal influence of the hot gas leads to internal stress and tension ending in an elastically expansion of the ring segment. This expansion creates an uneven and unfavorable tip gap to the rotor blades, which passes along the hot gas path boundary.

In the past the blade tip gap had to be large enough to account for the ring segment from thermally driven displacement relative to the blade tip. With that, the blade tip to ring segment gaps are larger than desired as with increasing gap size the fraction of the hot gas circumventing the airfoil without transforming its thermal energy into mechanical energy increases. This bypassing effect is known as tip loss as well and decreases the gas turbine efficiency.

Hence, a first object of the present invention is to provide a ring segment, which, when assembled in a gas turbine and operated therein, reduces the tip losses over the rotor blades. Second object of the present invention is to provide a method to operate a gas turbine more efficiently and a third object of the present invention is to provide a computer-implemented method to design and/or manufacture a ring segment contributing an increased performance of the gas turbine.

### SUMMARY OF THE INVENTION

In order to solve the aforementioned problems, a ring segment according to the present invention has the features of the independent claim.

The problem regarding to the operation method is solved by the method according to the claims and the problem regarding the method for designing and/or manufacturing the ring segment is solved by the features of the claims.

The invention is based on the idea to reduce the average radial gap between the tips of rotor blades and the opposite arranged surface of a ring segment for hot operation state.

In detail the invention proposes a ring segment for a gas turbine, comprising a base body having a first surface, which is, when assembled in the gas turbine and during its operation, subjected to a working medium, and a second surface which is arranged opposite of the first surface, wherein the first and second surfaces of the ring segment, when the latter is assembled in the gas turbine and in relation to the rotational axis of a rotor of the gas turbine, extends in a axial direction from a first axial end to a second axial end and in a circumferential direction from a first lateral end a second lateral end, and wherein the first surface comprises a nominal area along both axial ends which are curved along the circumferential direction and with a constant radius in relation to the rotational axis of the gas turbine, and wherein the nominal area delimits at least partially a center area of the first surface, the center area having a trough.

In other words: in the center of the first surface a trough is arranged as a deviation from a nominal area of the first surface, which surrounds the trough.

The “nominal area” or “nominal plane” is defined as an arced segment of the envelope of a right circular truncated cone or cylinder. The right circular truncated cone is also known as a frustum of a cone, wherein the envelope of the cone represents the outer flow path boundary having an opening angle different than zero. Conventional ring segments have first surfaces which completely matches with said segment a right circular truncated cone, such, that for cold operating condition a homogeneous radial gap distribution occurs, when correspondingly angled airfoil tips of rotor blades pass by during the rotation of the rotor.

The radial distance between the hot gas surfaces of the ring segments and the tips of the rotor blades, or more precise, the tip of the rotor blade airfoils, is in the following called radial gap and known as tip clearance as well. As each airfoil and with that, its tip as well, is of aerodynamically curved shape and has an extension in axial und circumferential direction, for a single blade not only one single radial gap exists. Contrarily, for each airfoil tip an infinity number of radial gaps exist, wherein for each considered location its radial gap depends on the considered location, the local shape of the airfoil tip, local the circumferential position of the rotor blade while rotating around the rotational axis of the gas turbine and the radial position of the first surface being opposite of the considered location. This space-resolved dependency of the radial gaps can be understood in general as “radial gap distribution” and in relation to its value to “variance” and “average radial gap”. Thus, the “average radial gap” is the mean value—of a number or indeterminate number—of distances between the first surface of the ring segment and the tip of a rotor blade, wherein the distances are determined or calculated, e.g., by simulations, at axially and/or circumferentially different locations of the relevant ring segment.

The terms “cold” and “hot” have to be understood that “cold” means room temperature or ambient temperature and “hot”′ means a temperature having a level, which leads to a relevant thermal growth and expansion, e.g., a temperature of multiple hundred degrees Celsius, of higher, up to a temperature level before the ring segment is damaged.

The “opening angle” of the outer flow path boundary is determined in relation to the rotational axis of the gas turbine. If the opening angle is zero, then—in cross section—the outer flow path boundary is parallel to the rotational axis.

The inventive shape of the first surface is, of course, without any consideration of manufacturing tolerances.

The invention is based on the knowledge that conventional ring segments suffers usually under a thermally driven expansion. In detail, conventional ring segments are assembled in a vane carrier in cold as well as in hot condition by aid of hooks located at the upstream end and downstream end in respect to the flow direction of the working medium and on a concentric circle. With that, at these locations nearly no expansion of the first surface is possible. Hence, the base body compensates at least partially the thermal load by the thermal expansion between the hooks, so that the first surface bents into the flow path of the working medium. This thermal expansion ends in an unsuitable shape of the first surface having a narrowest radial gap only in a small area at the point of maximum protrusion. The size of the radial gaps depends on the considered location and has a large variance, in comparison to the cold operation state. In other words: In hot operation state the radial gaps become very inhomogeneous, and their sizes differs significantly.

Now, the inventors propose to consider and compensate the thermal induced expansion of the ring segment upfront when designing the first surface. Hence, the new first surface must have in cold operation the opposite structure of the first surface of the conventional ring segment in hot operation state. Said that, instead of having a bulged first surface in hot operation state the inverted design of the inventive ring segment has in cold operation state a trough at the same location of the bulge. The thermal impact to the ring segment having in cold operation state a trough in its first surface leads in hot operation state to a ring segment with a significant flattened first surface, which theoretically could, as its best, being identical with the nominal area. The shape and the form of the trough, e.g., its length, width, and depth, depends on the overall design and dimensions of the ring segment, e.g., its size, its aspect ratio of length and width, thickness of the base body, the thermal load, and the like.

The ring segment the nominal area delimits completely the through located in the center area of the first surface by extending along both lateral ends as well. As the stiffness of the base body between the two lateral ends is in the mid-section smaller than at the lateral ends itself, it can be beneficial to have the nominal area extending along each lateral end from the first axial end to the second axial end. With that, the trough in the first surface is completely surrounded by an area of the first surface, which is identical to the nominal area as well.

This measure leads in hot operation state to space-resolved radial gaps which are significantly more homogeneous and having a reduced average radial gap and a smaller variance than in the prior art. The tip clearances are optimized in this regard. The more homogeneous radial gap distribution reduces in operation of the gas turbine the tip losses, which contributes to a gas turbine efficiency increase. In other words, the utilization of the inventive ring segment leads in hot operation state to an average radial gap which is smaller than the average radial gap of a prior art ring segment when operated in hot operation as well.

The advantages described for the ring segment apply analogously to the method to operate a gas turbine and to the method to design and/or manufacture a ring segment.

To solve the problem regarding the method to operate a gas turbine, the method according to the present invention has the features of the claims.

In detail, the method to operate a gas turbine comprising the ring segment according to the invention comprises the step of heating the ring segment to reduce an average radial gap between the airfoil tips and the center area in this hot operation state, compared to the average radial gap between the airfoil tips and the center area in cold operation state, of course, without considering the effects created by thermal impact and centrifugal forces on the rotor blades.

In order to solve the problems regarding the methods for designing and/or manufacturing the ring segment, the computer-implemented method according to the present invention has the features of the claims.

In detail, the computer-implemented method for designing and/or manufacturing a ring segment for a gas turbine, wherein the ring segment comprises a base body having a first surface subjectable to a working medium of the gas turbine and a second surface, which is opposite of the first surface and on which fastening elements are located at different axial positions, wherein multiple ring segments, when assembled in a gas turbine, form a portion of an annular outer flow path boundary of a working medium of the gas turbine, the portion of the annular outer flow path boundary is located opposite a row of airfoil tips of rotor blades,

comprises the steps of:
determining or providing a first surface embodied completely as a nominal area for cold operation state of the gas turbine by considering its axial position in the flow path, the radial distances of the first surface to the rotational axis of the gas turbine and/or the opening angle of the outer annular flow path boundary,
determining or providing the operational temperature distribution of the ring segment for hot operation state, especially steady operation state, of the gas turbine,
determining the hot operation contour of the first surface by considering the thermal expansion of the ring segment, especially the thermal expansion for multiple locations of the first surface based on the operational temperature distribution and preferable in relation to the nominal plane, and,
modifying the first surface in cold operation state away from a complete nominal area to a first surface comprising a troughed center area to reduce the average radial gap, compared to an average radial gap which is based on the hot operation contour of the first surface.

The term “considering” has to be understood that the features which are listed after the term are used to determine and/or calculate the respective feature of the sentence.

Further preferable embodiments are mentioned in the dependent claims, whereby their features could be easily combined in any way.

Preferable, the design method is computer-implemented method and with that, performed by a computer. Hence, the invention comprises a data processing apparatus as well having means for carrying out the steps of the design method.

Further, the invention comprises a computer program product comprising instructions which, when the program is executed by a computer, cause the computer to carry out the steps of the design method.

According to a first preferred embodiment of the ring segment the base body has a width, which is determined as the straight distance between the two axial ends and a length, which is determined as the curved distance between the two lateral ends, and wherein an aspect ratio of width to length is in the range between 0.15 and 4, especially in the range between 0.2 and 0.5.

Usually, heavy-duty gas turbine comprises ring segments having an aspect ratio in a range between 0.15 and 4, wherein the ring segments can be applied for all turbine stages. As the size of the radial gap in relation to the span size of the related rotor blade airfoils is for front stages of a turbine larger than for rear stages, the gain in turbine efficiency due to reduced tip losses is for front stages of the turbine larger than for rear stages. With that, the utilization of the ring segment according to the inventions makes most sense in front stages of a turbine having ring segments, which usually have an aspect ratio in the range between 0.2 and 0.5.

According to another preferred embodiment of the invention the trough has a maximal depth, which is less than 25% of the center thickness of the base body, or in comparison to the nominal area, which is less than 1.5 mm. Simulations and FEM calculations have shown best results in term of a reduced average radial gap when the maximal depth of the trough is about the before-mentioned size.

To avoid steps in the first surface leading to aerodynamical losses in the working medium and to consider the different local expansion and thermal growth of the base body, it is in accordance with another preferred embodiment beneficial that the center area comprises a transition between the nominal area and the maximum depth of the trough.

In accordance with another preferred embodiment the area of the maximum depth is of racetrack contour. This design is especially beneficial for ring segments having an aspect ratio of width to length significantly different from 1.

Preferably, the trough has a maximum depth compared to the nominal area, the maximum depth of the trough is located at 40% to 60% of the width axially from the first axial end and at a distance of 25 % to 75 % of the length circumferentially from the first circumferential end.

In another preferred embodiment of the ring segment according to the invention, the first surface comprises a coating system with one or multiple coating layers, preferable metallic and/or ceramic locating layers and/or the base body comprises cooling channels. With that, the invention is not only applicable for uncoated and/or uncooled ring segments. The invention can be beneficially utilized for coated and/or cooled ring segments as well.

Regarding another preferred embodiment of the method for designing and/or manufacturing a ring segment, the radial length of fastening elements of the ring segments, especially embodied as hooks or rails, are adjusted after finishing the step of the determination of the modified first area. As the bulging effect of the base body of a conventional ring segment has not anymore to be considered when the size of the radial gap is to be specified, the nominal area of the first surface can be shifted towards the tips of the rotor blades by increasing the radial length of the hooks or rails. This measure also contributes to a reduction of the average radial gap leading to an increase efficiency of the gas turbine.

Preferably, after designing the ring segment, the ring segment is manufactured, more especially by casting and/or machining or by an additive manufacturing process, in particular by Laser-Powder Bed Fusion (LPBF). The latter manufacturing method is best suitable for creating parts having complex throughs shapes and others as descripted herein.

### BRIEF DESCRIPTION OF THE DRAWINGS

Further advantages and features of the invention will be apparent from the following description based on the drawings. Thereby showing:

FIG. 1 schematically a gas turbine,

FIG. 2 a conventional ring segment in a perspective view,

FIG. 3 a cross-section through the conventional ring segment of FIG. 2,

FIG. 4 an exemplary embodiment of a ring segment according to the invention in a perspective view,

FIG. 5 a cross-section through the exemplary embodiment of a ring segment of FIG. 4,

FIG. 6 a schematic cross-section through a coated cooled ring segment and

FIG. 7 a flow chart for designing and manufacturing a ring segment.

### DETAILED DESCRIPTION OF EMBODIMENTS

Embodiments according to the present invention will be described below with reference to the drawings. In all drawings, the same features are provided with the same reference signs.

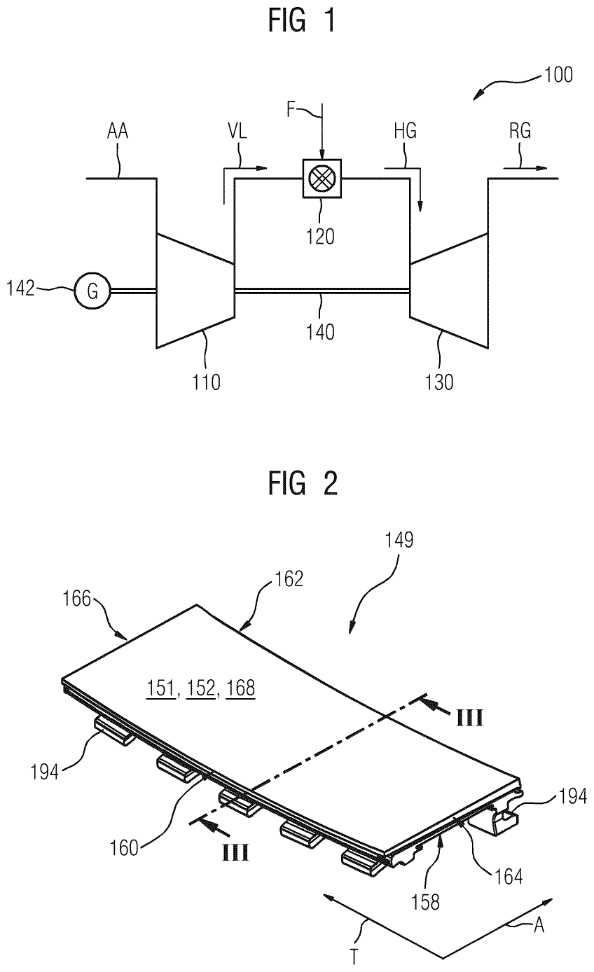

FIG. 1 shows schematically a gas turbine 100 with a compressor 110, a combustion chamber 120 and a turbine unit 130. According to this exemplary embodiment, an electrical generator 142 for generating electricity is coupled to a rotor 140 of the gas turbine. During Operation ambient air AA is sucked in by the axial compressor 110. The ambient air is conveyed through the compressor while getting compressed along the way. The compressed air VL is then mixed with a fuel F in the combustion chamber 120 and burned to a hot gas HG. The hot gas HG expanded in the turbine unit 130 and leaves it as flue gas RG. The expansion of the hot gas HG generates torque in the turbine unit 130 onto the rotor 140, which then drives the compressor 110 and the electrical generator 142.

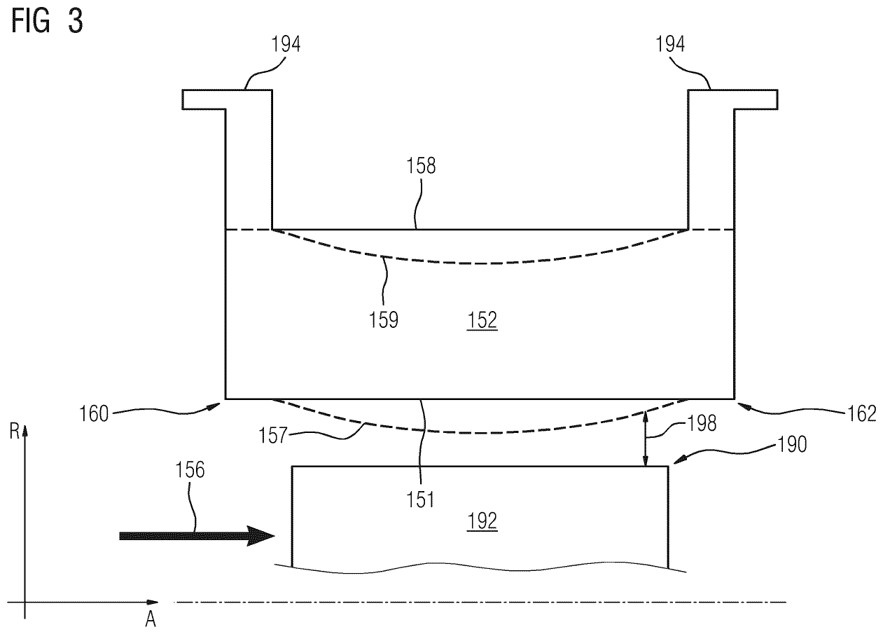

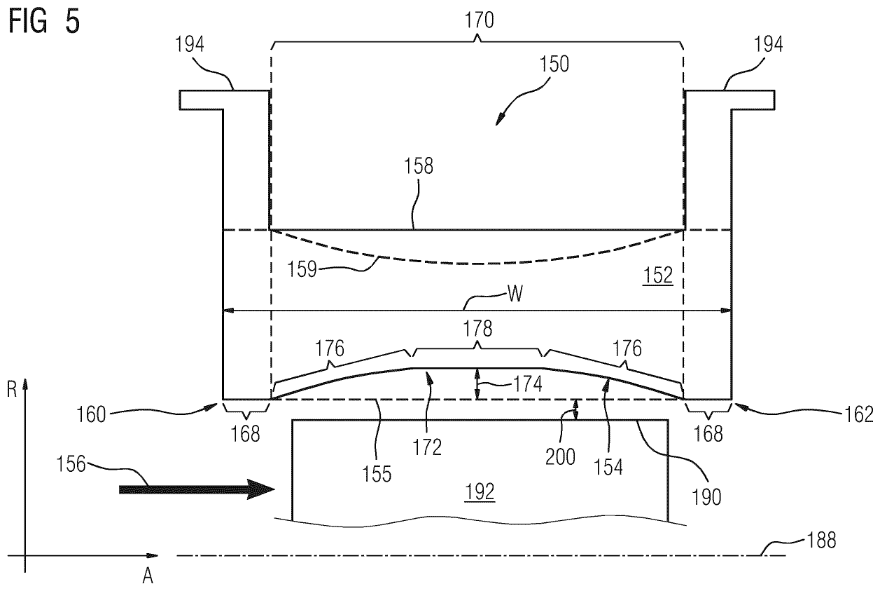

FIG. 2 shows a conventional ring segment 149 in a perspective view for cold operation state. The ring segment of 149 comprises a base body 152 of predominantly rectangular shape. When the ring segment 149 is assembled in the gas turbine 100, its base body 152 extends in an axial direction A from a first axial end 160 to a second axial end 162. The two axial ends 160, 162 can also be understood as an upstream leading edge and the downstream leading edge of the ring segment 149, in relation to the flow direction of the working medium 165 (shown in FIGS. 3, 5). Further, the base body 152 extends in a circumferential direction T from the first lateral end 164 and second lateral end 166. Both, the axial direction A and the circumferential direction T, are in relation to the rotational axis 188 of the gas turbine 100, around which its rotor 140 rotates during operation. With that, the two edges of the base body 152 extending along the circumferential direction T between the two lateral ends 164, 166 are of circular shape. The other two edges of the base body 152 extending along the axial direction A from one axial end 160, 162 to the other axial end 162, 160 are straight.

Usually, the conventional ring segment 149 comprises a first surface 151, which faces and borders the flow path (not shown) of the gas turbine. During operation of the gas turbine 100, the first surface 154 is subjected to a working medium 156. The base body 152 comprises the second surface 158, which is located opposite from the first surface 151. From the second surface extends as fastening elements 194 two rows of hooks at first in radial direction R (FIG. 3). Those hooks are able to engage into correspondingly shaped grooves of a vane carrier (not shown).

Ignoring manufacturing tolerances, the first surface 151 is identical to a segment of the right circular truncated cone, provided, that the outer boundary of flow path increases or decreases along its axial direction. However, if the ring segment 149 is used in a flow path, which outer boundary has an opening angle of zero, then the first surface has a cylindrically shape, instead having the shape of the right circular truncated cone.

FIG. 3 shows in cross-section III-III the conventional ring segment 149 of FIG. 2 and an airfoil tip 190 of a rotor blade 192, which are located opposite of the first surface 154. The airfoil tip 190 is correspondingly angled to the opening angle of the outer flow path boundary, i.e., the airfoil tip 190 is parallel to the outer flow path boundary. Solid lines of FIG. 3 show the shape of the ring segment 149 in the cold operation state, whereas dashed lines 157, 159 shows the hot operation contour of the first and second surfaces 151, 158 as results of the thermal growth and expansion appearing during the hot operation state.

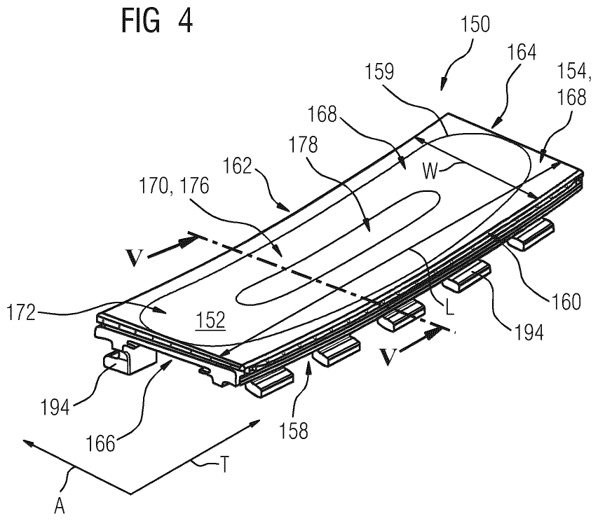

The cold operation contour of the base body 152 changes to a bulged shape, which is displayed in FIG. 4 dashed lines 157, 159, after the gas turbine has been started cold. In hot operation state the second surface 158 comprises a trough whereas the first surface 151 comprises a bulge or a peak protruding into the flow path. An average radial gap 198 can be determined between the airfoil tip 190 and the first surface 151 and has a larger variance because of its shape.

FIG. 4 shows an exemplary embodiment of a ring segment 150 according to the invention in a perspective view. In the following the features of the ring segment 150 are described the cold operation contour 159, i.e., without any thermal growth and expansion. Contrary to the conventional ring segment 149, the ring segment 150 according to the invention comprises in its first surface 154 a trough 172 in the center area 170. The center area 170 of the first surface 154 is at least partially delimited by a nominal area 168 of the first surface 154, which nominal area 168 at least extends along the circumferential direction T between the two lateral ends 164, 166 along the first and second axial ends 160, 162. The center area 170 and the nominal area 168 of the first surface 154 merges into one another without any step.

The trough 172 is in the exemplary embodiment of racetrack shape comprising a flat area 178 having a maximum depth 174 (FIG. 5) of 1 mm. The transition 176 connects as a slope the area 178 of the maximum depth 174 with the nominal area 168 of the first surface 154 on each merging position without any step.

A width W of ring segment 150 is determined as the straight distance between the two axial ends 160, 162 and a length L is determined as the curved distance between the two lateral ends 164, 166. The aspect ratio of width to length W/L of the in this exemplary embodiment of the ring segment 150 is 0.3 and with that, in the range between 0.15 and 4.0, especially in the range between 0.2 and 0.5.

FIG. 5 shows the exemplary embodiment of the ring segment 150 of FIG. 4 in cross-section V-V and an airfoil tip 190 of a rotor blade 192, which are located opposite of the first surface 154. The airfoil tip 190 is correspondingly angled to the opening angle of the outer flow path boundary, i.e., the airfoil tip 190 is parallel to the outer flow path boundary. Solid lines of FIG. 5 show the shape of the ring segment 150 in the cold operation state, whereas the dashed lines 155, 159 shows the amended contour of the first and second surfaces 154, 158 due to thermal growth and expansion in hot operation state.

Due to the troughed shape of the first surface 154 of the ring segment 150 in cold operation state, i.e., room temperature, the impact of heat in a range of several hundred degree Celsius, or up to 1200° C., leads to an expansion of the base body 152, which is displayed, as mentioned before, in dashes line 155, 159. Same as for the conventional ring segment 149, the cold straight second surface 158 of the ring segment 150 changes into a trough when subjected to heat. However, the first surface 154 comprising the trough 172 deforms, when the ring segment 150 is subjected to heat and thermal load, into a shape, which is a significantly flatter than in cold operation state. When perfectly simulated, calculated, manufactured, and depending on the actual thermal load, the first surface 154 might change its shape to a completely flat hot contour 155.

With the new shape 155 of the first surface 154 in hot operation state, the average radial gap 200 is smaller than the average radial gap 198 of the conventional ring segment 149. This leads to a decrease of tip losses in the working medium 156 and to an increased efficiency of the gas turbine 100.

This thermal behavior of the ring segment 150 enables the designer of the gas turbine to reduce the cold radial gap between the airfoil tip 190 and the ring segment 150, too. This can be achieved easiest by extending the radial length of the fastening elements 194, e.g., the hooks, which are arranged on the second surface 158 of the ring segment 150. This measure contributes to a further decrease of tip losses in the working medium 156 as well.

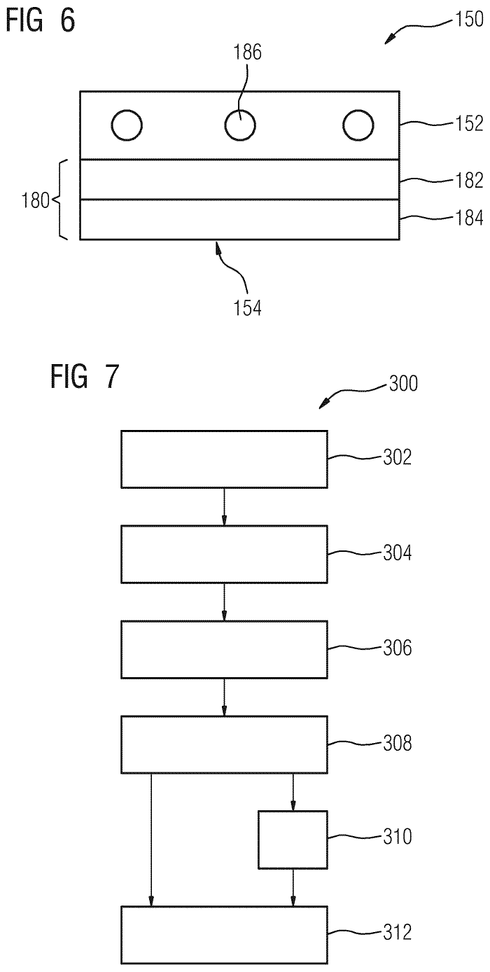

FIG. 6 shows a schematic cross-section through the base body 152 of a coated and cooled ring segment 150. For the sake of easiness, the trough and other features are omitted in FIG. 6. In the interior of the base body 152 three cooling channels 186 are located. Other cooling concepts like impingement cooling concepts can be applied alternatively or in addition to the internal convective cooling.

Again, in addition or alternatively to the cooling of the ring segment, the base body 152 can serve as a substrate for a coating system 180, which, in this example comprises two coating layers, e.g., one metallic coating 182 and one ceramic coating 184. Other coating systems are also possible. In each case the first surface 154 of the coated ring segment 150 still have to comprise the center area 170 having a trough 172.

FIG. 7 a flow chart for a method to design and manufacture a ring segment according to the invention. The method 300 for designing and/or manufacturing a ring segment, especially a ring segment according to the invention, comprises multiple steps.

In a first step 302 for cold operation state of the gas turbine 100 the first surface 151 is determined to be identical with a nominal area as a portion of an annular outer flow path boundary, wherein the radial distances of the first surface 151 to the rotational axis 188 of the gas turbine 100 and the opening angle of the outer annular flow path boundary are considered. The opening angle of the outer flow path boundary is identical to the angle of the frustum cone mentioned above.

In a next step 304 the operational temperature distribution of the ring segment 150 for hot operation state, especially steady operation state, of the gas turbine 100 is determined.

In a following step 306 the hot operation contour 157 of the first surface 151 is determined by considering the thermal growth of the ring segment, especially the thermally induced expansion of the first surface for multiple points of the first surface 151 based on the operational temperature distribution and in relation to the nominal area.

In a final step 308 the first surface 151 in cold operation state is modified from a complete nominal area to a shape comprising a troughed center area 170. This troughed center area of the modified first surface 154 leads in a reduced average radial gap 200 between the first surface 154 in hot operation state and the airfoil tips 190, compared to an average radial gap between first surface 154 in cold operation state and the airfoil tips 190. Preferably, the first surface is designed such, that its hot operation contour 155 matches the contour of segment of a right circular truncated cone or cylinder to at least 90%, or more.

The thermal growth of the ring segment and especially of its base body 152 has to be taken into account when the radial gap between the first surface and the airfoil tip 190 has to be specified during the design phase of the gas turbine to avoid a contact of the airfoil 190 with the base body. When an abradable coating is utilized on the ring segment, not any contact is to avoid but rather such a contact, which would harm the airfoil tips 190, the base body and/or the abradable coating more than intended.

Preferably, after designing the ring segment 150 and adjusting the radial length of the fastening elements 194 in an optional resp. supplemental step 310, the ring segment 150 can be manufactured in a last step 312.

The manufacturing can be performed either by casting and/or machining. Or the manufacturing step comprises the manufacturing by an additive manufacturing, e.g., by selective Laser-Powder bed Fusion (LPBF).

It should be noted that the term “comprising” does not exclude other elements or steps and “a” or “an” does not exclude a plurality. Also, elements described in association with different embodiments may be combined. It should also be noted that reference signs in the claims should not be construed as limiting the scope of the claims. Although the invention is illustrated and described in detail by the preferred embodiments, the invention is not limited by the examples disclosed, and other variations can be derived therefrom by a person skilled in the art without departing from the scope of the invention.

1. A ring segment for a gas turbine, comprising:
a base body having a first surface subjectable to a working medium of the gas turbine, and a second surface, which is arranged opposite of the first surface,
wherein the first surface of the ring segment, when the ring segment is assembled in the gas turbine and in relation to a rotational axis of a rotor of the gas turbine, extends in a axial direction from a first axial end to a second axial end and in a circumferential direction from a first lateral end to a second lateral end,
wherein the first surface comprises a nominal area, which extends along both axial ends and is curved along the circumferential direction with a constant radius in relation to the rotational axis of the gas turbine,
wherein the nominal area delimits at least partially a center area of the first surface, the center area comprising a trough, and
wherein the nominal area delimits completely the trough located in the center area of the first surface by extending along both lateral ends.

2. The ring segment according to claim 1,
wherein the base body has a width, which is determined as a straight distance between the first and second axial ends and a length, which is determined as a curved distance between the first and second lateral ends, and
wherein an aspect ratio of width to length is in a range between 0.15 and 4.

3. The ring segment according to claim 1,
wherein the trough has a maximal depth, which is less than 25% of the center thickness of the base body, or in comparison to the nominal area, which is less than 1.5 mm.

4. The ring segment according to claim 1,
wherein the center area comprises a transition between the nominal area and the maximum depth of the trough.

5. The ring segment according to claim 4,
wherein the area of the maximum depth is of racetrack contour.

6. The ring segment according to claim 2,
wherein the trough has a maximum depth compared to the nominal area, the maximum depth of the trough is located at a distance of 40% to 60% of the width axially from the first axial end and at a distance of 25 % to 75 % of the length circumferentially from the first circumferential end.

7. The ring segment according to claim 1, further comprising:
on the first surface a coating system with one or multiple coating layers, and/or
one or more cooling channels in the base body.

8. A gas turbine, comprising:
multiple ring segments according to claim 1,
wherein the multiple ring segments are arranged to establish a portion of an annular outer flow path boundary of a working medium of the gas turbine, the portion of the annular outer flow path boundary is located opposite a row of airfoil tips of rotor blades.

9. A method to operate a gas turbine according to claim 8,
operating the gas turbine in a hot operation state, wherein due to a heating of the ring segment the actual depth of the trough decreases to reduce an average radial gap between the airfoil tips and the first surface in the hot operation state, compared to the average radial gap between the airfoil tips and the first surface when operating in a cold operation state.

10. A computer-implemented method for designing and/or manufacturing a ring segment for a gas turbine,
wherein the ring segment comprises a base body having a first surface subjectable to a working medium of the gas turbine and a second surface, which is opposite of the first surface and on which fastening elements are located at different axial positions,
wherein multiple ring segments, when assembled in a gas turbine, form a portion of an annular outer flow path boundary of a working medium of the gas turbine, the portion of the annular outer flow path boundary surrounding a row of airfoil tips of rotor blades and forming radial gaps therebetween,
the method comprising the steps of:
determining or providing a first surface embodied completely as a nominal area for cold operation state of the gas turbine by considering its axial position in the flow path, radial distances of the first surface to a rotational axis of the gas turbine and/or an opening angle of the outer annular flow path boundary,
determining or providing an operational temperature distribution of the ring segment for hot operation state, of the gas turbine,
determining a hot operation contour of the first surface by considering a thermal growth of the ring segment, and,
modifying the first surface in cold operation state away from a complete nominal area to a first surface comprising a troughed center area to reduce an average radial gap, compared to an average radial gap based on the hot operation contour of the first surface.

11. The method according to claim 10,
wherein a radial length of the fastening elements, hooks or rails, of the ring segment are adjusted after finishing the determination of the modified first area.

12. The method according to claim 10,
wherein after designing the ring segment, the ring segment is manufactured.

13. The method according to claim 12,
wherein the ring segment is manufactured by casting and/or machining or by an additive manufacturing process, and/or by Laser-Powder Bed Fusion (LPBF).

14. A data processing apparatus, comprising:
means for carrying out the steps of the method according to claim 10.

15. A non-transitory computer program product, comprising:
instructions stored thereon which, when the instructions are executed by a computer, cause the computer to carry out the steps of the method according to claim 10.

16. A non-transitory computer-readable storage medium, comprising:
instructions stored thereon which, when executed by a computer, cause the computer to carry out the steps of the method according to claim 10.

17. The ring segment according to claim 2,
wherein an aspect ratio of width to length is in the range between 0.2 and 0.5.

18. The ring segment according to claim 7,
wherein the one or multiple coating layers comprise metallic and/or ceramic locating layers.

19. The method according to claim 10,
wherein the step of determining or providing the operational temperature distribution of the ring segment for hot operation state, comprises a steady operation state, of the gas turbine.

20. The method according to claim 10,
wherein the step of determining the hot operation contour of the first surface by considering the thermal growth of the ring segment, comprises considering a thermal expansion for multiple locations of the first surface based on the operational temperature distribution and in relation to the nominal plane.
